(19) United States
(12) Patent Application Publication
(10) Pub. No.: US 2007/0269305 A1
(43) Pub. Date: Nov. 22, 2007

(54) Waterborne power generator

(76) Inventor: Donald E. Burg, Miami, FL (US)

Correspondence Address: Donald E. Burg, 15840 S.W. 84th Avenue, Miami, FL, 33157, US

(21) Appl. No.: 11/456,000

(22) Filed: Jun. 20, 2006

Related U.S. Application Data
(63) Continuation-in-part of application No. 11/435,599, filed on May 17, 2006.

(51) Int. Cl. F03D 7/06

(52) U.S. Cl. 415/4.2

(57) ABSTRACT

Presented is a physically and environmentally attractive fluid energy powered rotor driven power generation system that is attached to an anchored waterborne device such as a boat hull such that the power generation device is automatically directed so that its water inlet is facing oncoming water currents. In its optimum configuration, it achieves high efficiencies by redirecting incoming fluids forward to add positive rotational energy to a side of the rotor what would otherwise have an anti-rotational drag force component. The power generation system is, in its preferred arrangement, rotatable so that it may be removed from the water for cleaning or during transport of the waterborne device. A remotely controlled buoy system may be incorporated to raise or lower the anchoring line.

### CROSS REFERENCE TO OTHER APPLICATIONS

This application is a continuation-in-part to U.S. applications Ser. No. 11/435,599 filed May 17, 2006 and Ser. No. 11/443,978 filed May 30, 2006.

### BACKGROUND OF THE INVENTION

Means to extract energy from nature's wind and water currents have been many over the years as is evidenced from the prior art. Most successful units to current state-of-the-art technology, both small residential size and very large commercial units, are wind turbines with a horizontal axis and several airfoil shaped blades. There have also been successful vertical axis wind turbines that have the advantage of locating the turbine and gears on the ground with the rotor above. However the vertical axis units are generally less efficient due to their rotor blade configurations. The fluid energy is captured on the downwind rotational side or working side of the turbine blades in this most common approach. However, there is a force working against rotation that occurs when the blades rotate upwind during the other half of the rotor's rotation. The most efficient concepts use variations of airfoil shaped blades that rotate at speeds above oncoming wind velocities. FIG. 1 of this application shows a generic version of a prior art vertical axis wind turbine rotor with three airfoil shaped blades. Note how the force of the oncoming fluid is working against rotation when the blades are going upwind.

Examples of prior art vertical axis wind turbines with turbine blades similar in configuration to FIG. 1 of this application include: Dereng, U.S. Pat. No. 4,264,279 and Kato, et al, U.S. Pat. No. 4,285,636.

Applicant's instant invention addresses the shortcomings of both vertical and horizontal axis fluid turbines in a highly efficient yet low cost and low maintenance design. This is accomplished, in the preferred embodiment of the invention, by reversing direction of the passing fluid on what would normally be the upwind or up fluid rotational side of the rotor so that such reverse directed fluid acts to generate positive rotational forces. In summary, the instant invention offers a low cost fluid energy converting power generation device that is more efficient than prior art vertical axis wind or water turbines. It does this while offering most all of the advantages that a vertical axis rotor turbine generator has over state-of-the-art horizontal axis airfoil blade turbine generators. Further, it may be oriented at any angle to vertical including horizontal which is the preferred embodiment.

One advantage of the prior art exposed rotor vertical axis turbines is that they are omni-directional as far as oncoming wind is concerned. While this has it advantages it also has shortcomings. The exposed rotors of the prior art vertical axis turbines are subject to damage from flying objects, are inherently weak from a structural standpoint, and are environmentally unfriendly to birds and other wildlife. Applicant's continuation-in-part applications address wind and/or water turbines that have vertical axes and, in most cases, must be rotated to face oncoming fluids, as do present day horizontal axis propeller blade type wind turbines, but has protection for its rotors, is structurally very sound, and is environmentally friendly to wildlife and neighbors. Its environmental friendliness can be further enhanced by addition of grilles over fluid inlet and discharges.

The instant invention describes a water turbine that has blades more or less parallel and not perpendicular to the axis. It is preferably mounted proximal to and supported by a waterborne device such as a boat or barge. It is generally lowered to immerse the driven elements of the turbine into the passing water currents. This is particularly attractive when working in constant water current streams such as the Gulf Stream and tidal current streams such as seen in San Francisco Bay. A big disadvantage of prior art water turbines installed in such just noted areas is that they are subject to growth by all kinds of marine organisms. In the case of the instant invention it is possible to retract the driven turbine elements from the water for cleaning and maintenance. It is a further major advantage that, since the water turbine is mounted on a waterborne device, the instant invention's water inlet is automatically pointed upstream since the forward end of the supporting waterborne device is preferably anchored so that it is pointed upstream no matter the direction of the oncoming water current or stream. It is further important aspect of the instant invention that it is easy to start rotation and to run with very low speed incoming fluids.

A further feature of the instant invention is that it has been purposely conceived to be built in easily transportable pre-fabricated low cost modules. The pre-fabricated modules are very simple to assemble together as a complete wind or water current powered turbine generator. The advantages of the present invention will be understood upon review of the following sections.

### SUMMARY OF THE INVENTION

A primary object of the instant invention is to provide a fluid energy powered rotor driven power generation system with said fluid energy powered rotor having fluid energized rotor blades wherein said fluid energized rotor blades absorb energy from oncoming passing fluid currents with said energy transmitted to a power generator for conversion to useful power.

A directly related object of the invention is that a waterborne supporting device support said fluid energy powered rotor driven power generation system wherein said waterborne device is attached to non-moving structure by means of connecting means such that said waterborne supporting device automatically orients the fluid energy powered rotor driven power generation system to be facing oncoming passing fluid currents.

A further related object of the invention is that at least a majority of the fluid energized rotor blades may be raised above a surface of passing fluids currents.

Another object of the invention is that the fluid energized rotor blades absorb energy from rearward flowing incoming fluid during a first portion of rotation of said fluid energy powered rotor and absorb energy from incoming fluid that has been at least partially redirected by fluid flow turning means to be forward flowing over a second portion of rotation of said fluid energy powered rotor thereby providing positive rotational energy over a majority of the rotation of the fluid energy powered rotor.

Yet another object of the invention is that the fluid flow turning means may include fluid flow turning vanes.

Still another object of the invention that improves its efficiency is that it may include flow separation means wherein said flow separation means separates incoming fluid flow to opposite sides of the fluid energy powered rotor.

A related object of the invention is that at least portions of the flow separation means is attached to the waterborne supporting device thereby making said flow separation means fixed in relation to the waterborne supporting device.

A another object of the invention that increases its efficiency is the optional use of frontal area increasing outward boundary means that increase the amount of incoming flow directed to the fluid energized rotor blades.

A directly related object of the invention is that the frontal area increasing outward boundary means may include stationary curvilinear elements.

A further object of the invention is that it be constructed from pre-fabricated modules.

A directly related object of the invention is that such pre-fabricated modules include a base module and one or more rotor modules.

Another object of the invention is that it may include one or more fluid flow grilles that prevent objects, including wildlife and debris, from entering the rotor(s).

A further object of the invention is that the fluid energized rotor blades rotate around an axis that is more horizontal than vertical.

Another object of the invention is that the fluid energized rotor blades rotate around an axis that is more vertical than horizontal.

A further object of the invention is that the connecting means may include a buoy and wherein said buoy may be filled with gas thereby raising said buoy and attached connecting means to a water surface or filled with water thereby lowering said buoy and attached connecting means below the water surface.

A directly related object of the invention is that venting and filling of the buoy may be accomplished by remote control means.

### BRIEF DESCRIPTION OF THE DRAWINGS

FIG. 1 is a cross-section of a prior art fluid rotor that is being rotationally driven by oncoming fluids. This is the arrangement of some vertical axis wind turbines. Note that the driving fluid is pushing on the rotor blades on the downwind or working part of rotation and acting against rotation on the upwind part of rotation. These forces are there whether the oncoming fluid is air or water it is just that water is about 800 times denser than air and hence exerts a much larger force on the rotor blades.

FIG. 2 presents a cross-section, as taken through plane 2-2 of FIG. 6, of a preferred embodiment fluid rotor and preferred embodiment related structure to the instant invention. Note that: 1) More incoming fluid is directed toward the rotor due to the enlarged capture area forward of the rotor and 2) Incoming fluid that would normally work against rotation on the upwind or upwater side of rotation has been redirected so that it adds positively to rotational force rather than creating a parasitic rotational drag force as is the case for the prior art rotor presented in FIG. 1.

FIG. 3 presents a cross section of a mounting base assembly including a power generator and gearing.

FIG. 4 is a cross section, as taken through plane 4-4 of FIG. 3, that shows workings of gears that drive the power generator. Note that, while an electric generator is most common, any type of power generator including hydraulic or other may be used to absorb the rotational power from the turbine rotor(s).

FIG. 5 shows a side view of a rotor assembly module to a preferred embodiment of the instant invention.

FIG. 6 gives an end view of the rotor assembly module of FIG. 5.

FIG. 7 presents a side view of an assembled unit to the instant invention. In this instance there are two rotor modules.

FIG. 8 presents an end view of a cover as seen in FIG. 7.

FIG. 9 shows a top view of a waterborne object or device, in this case a pointy bow boat, with its deck covering removed that contains a Waterborne Power Generator.

FIG. 10 gives a centerline view, as taken through plane 10-10 of FIG. 9, that shows a Waterborne Power Generator in a vertically extended position so that it is absorbing power from passing water.

FIG. 11 is a bow on view of the vessel of FIG. 9 showing the Waterborne Power Generator in its downward extended position.

FIG. 12 presents a partial cross-section, as taken through line 12-12 of FIG. 9 but with the Waterborne Power Generator in its up or retracted position. Note that this position allows for easy cleaning and maintenance of the unit's components as well as for moving the waterborne device.

FIG. 13 shows a proposed anchoring device for the cable(s) connected to the waterborne device.

FIG. 14 shows a buoy or similar device that is, in this instance, is out of the way to passing vessels since it is filled with water and thereby sunk so that it is adjacent to the seafloor.

FIG. 15 illustrates what happens when the buoy is filled with gas so that it floats.

FIG. 16 shows means to fill and to vent the buoy. Gas from a compressed gas container expels the water thereby causing the buoy to float upward and raise the cable(s).

FIG. 17 is a topside view, with deck covering removed, of a waterborne device that is supporting another variant of the instant invention. In this instance, the axis of rotation is horizontal.

FIG. 18 gives a cross sectional view, as taken through line 18-18 of FIG. 17, that shows a plan view of the water turbine part of the instant invention.

FIG. 19 is a bow on view of the waterborne device showing the turbine portion of the Waterborne Power Generation System that in this case is horizontally oriented.

FIG. 20 shows a partial section, as taken through plane 20-20 of FIG. 17, but with the Waterborne Power Generator in its upper raised position.

FIG. 21 is a cross section, as taken through plane 21-21 of FIG. 18, that shows the preferred arrangement of the power generator and of its driving gear arrangements wherein the generator itself is perpendicular to the axis of rotation.

FIG. 22 present a profile view of the aft end of a waterborne device with a slightly different arrangement than given in FIGS. 17-20.

FIG. 23 gives a bow on view of the waterborne device with the Waterborne Power Generator in its lowered powered generating position.

FIG. 24 presents a cross sectional view, as taken through plane 24-24 of FIG. 23.

FIG. 25 shows this variant of the Waterborne Power Generator in its raised position.

FIG. 26 presents and end view of one of the rotor assemblies. Note that this rotor is actually similar to that presented as the prior art in FIG. 1.

FIG. 27 is a side or profile view of the rotor shown in FIG. 26.

### DETAILED DESCRIPTION

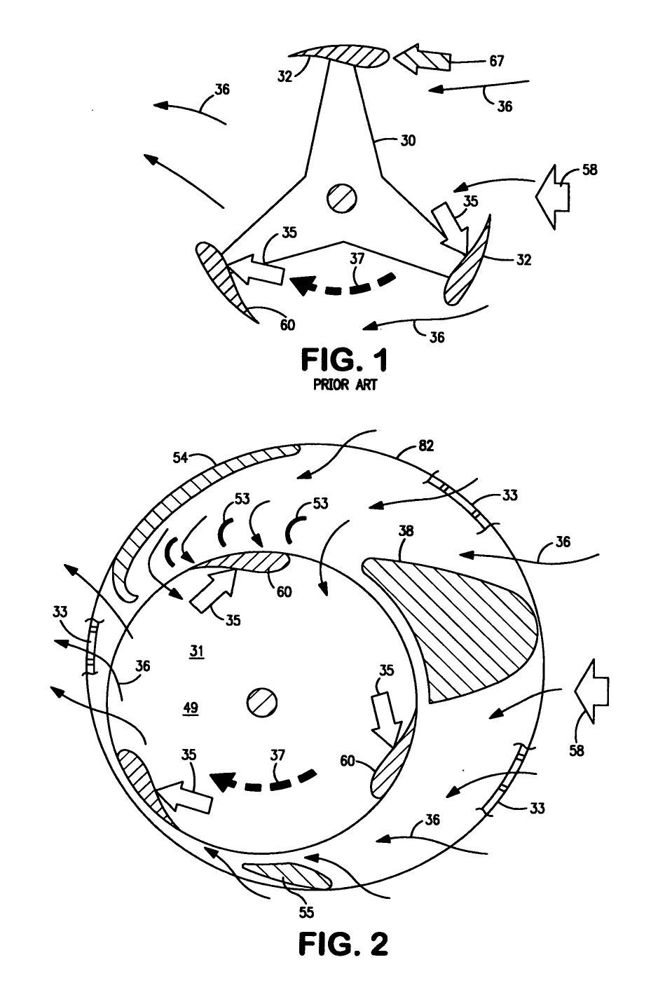

FIG. 1 is a cross-section of a prior art fluid rotor 30 that is being rotationally driven by oncoming fluids as shown by fluid flow arrows 36. This is the arrangement of some vertical axis wind turbines. Note that the driving fluid is pushing on the rotor blades 32 on the downwind or working part of rotation and acting against rotation on the upwind part of rotation This is indicated by positive force arrows 35 and negative force arrow 67. These forces are there whether the oncoming fluid is air or water, it is just that water is about 800 times denser than air and hence exerts a much larger force on the rotor blades 32. Rotational direction is shown by rotation arrow 37 and incoming fluid is shown by incoming flow arrow 58.

FIG. 2 presents a cross-section, as taken through plane 2-2 of FIG. 6, of a preferred embodiment fluid rotor 49 and preferred embodiment related structure 82 to the instant invention. Note that: 1) More incoming fluid is directed toward the rotor 49 due to the enlarged capture area forward of the rotor 49 and 2) Incoming fluid that would normally work against rotation on the upwind or upwater side of rotation has been redirected so that it adds positively to rotational force rather than creating a parasitic rotational drag force as is the case for the prior art rotor presented in FIG. 1. A very important aspect of this figure is that there are turning vanes 53 that redirect oncoming fluids 36 so that they are adding to positive rotational force rather than subtracting from it as was the Prior Art case presented in FIG. 1. Shown are optional inlet nacelle 38, flow control side members 55, and grille(s) 33.

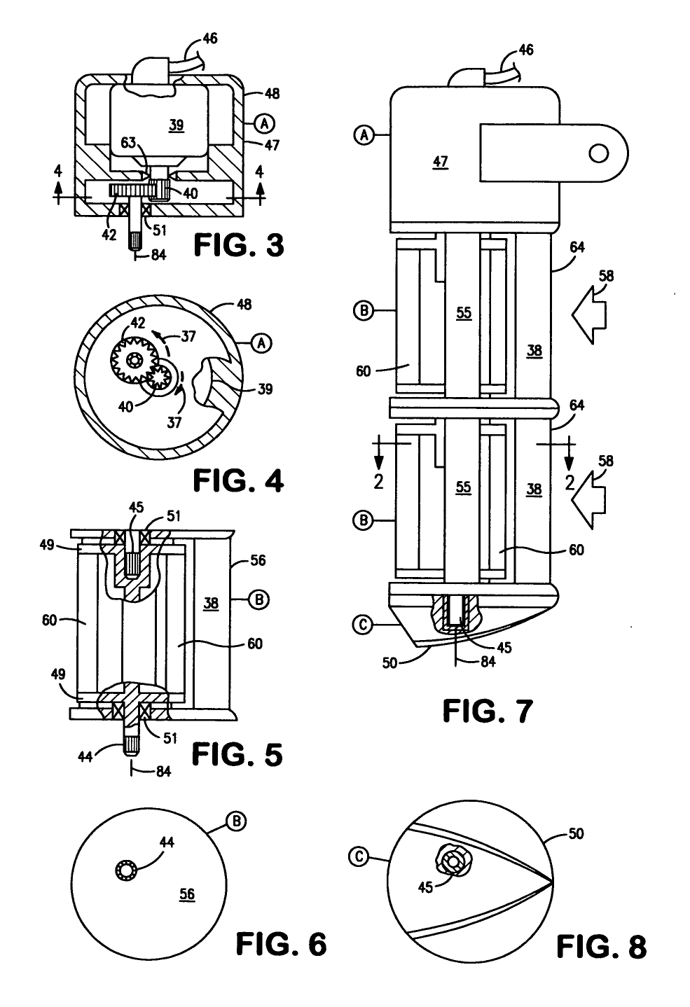

FIG. 3 presents a cross section of a mounting base assembly (A) 47 including a power generator 39 of a vertically oriented variant of the instant invention Waterborne Power Generator 64. On top of that is an adapter assembly or module (B) 48 that normally includes gearing 42 that drives the generator gear 40. The procedure for assembly at a site is to first position and set the mounting base assembly (A) 47. Other items shown are shaft bearing 51, seals 63, rotational drive motor and gear 41, and axis of rotation 84.

FIG. 4 is a cross section, as taken through plane 4-4 of FIG. 3, that shows workings of gears 42 that drive the power generator gear 40. Note that, while an electric generator is most common, any type of power generator 39 including hydraulic or other may be used to absorb the fluid power from the turbine rotor(s). Further, it may be desirable to incorporate a disconnect clutch, not shown, so that the power generator 39 may be disengaged for maintenance or during very high fluid velocity situations.

FIG. 5 gives a side view of the rotor assembly module (C) 56. Cutaway views show shaft support bearings 51, female spline/bearing adapter 45, and male spline adapter 44. A further cutaway view shows portions of a rotor 31 including rotor end plates 49.

FIG. 6 shows an end view of a rotor assembly module (C) 56 of FIG. 5 including a splined drive shaft 44 to a preferred embodiment of the instant invention.

FIG. 7 presents a side view of a Waterborne Power Generator 64 in a vertical orientation. Note how modules (A), (B), and (C) work together as pre-fabricated pieces to complete this vertical Waterborne Power Generator 64.

FIG. 8 is an end view of a cover (D) 50 including a female bearing adapter 45 to a preferred embodiment of the instant invention.

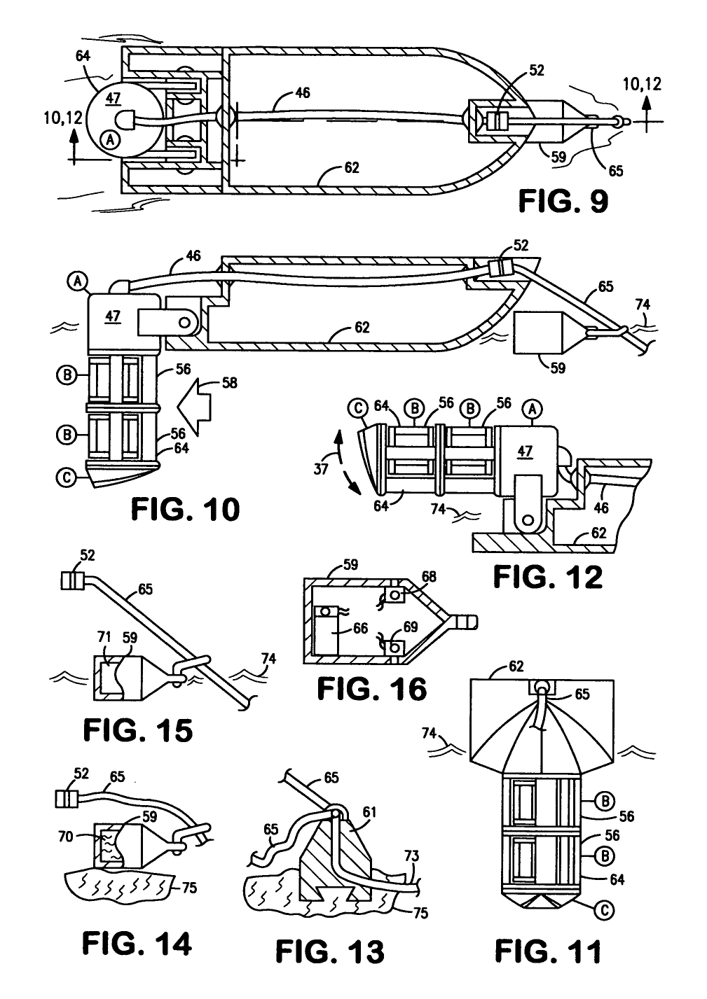

FIG. 9 shows a top view of a waterborne object or device 62, in this case a pointy bow boat, with its deck covering removed that contains a vertically oriented Waterborne Power Generator 62 Other items shown here include connector 52, anchor line cable 65, and float 59.

FIG. 10 gives a centerline view, as taken through plane 10-10 of FIG. 9, that shows the vertical Waterborne Power Generator 64 in its vertically extended position so that it is absorbing power from passing water indicated by main flow arrow 58. A waterline 74 is also shown.

FIG. 11 is a bow on view of the waterborne device 62 of FIG. 9 showing the vertical Waterborne Power Generator 64 in its downward extended position where it absorbing full force from passing water currents.

FIG. 12 presents a partial cross-section, as taken through line 12-12 of FIG. 9 but with the Waterborne Power Generator 64 in its up or retracted position. Note that this position allows for easy cleaning and maintenance of the unit's components as well as for moving the waterborne device 62.

FIG. 13 shows a proposed anchoring device 61 for the cable(s) 65 connected to the waterborne device. Cables 65 both in their extended upward and down orientations are shown for illustration purposes. A typical shore cable 73 that may pass under the seabed 75 is also shown.

FIG. 14 shows a device such as a buoy 59 that is, in this instance, is out of the way to passing vessels since it is filled with water 70 and thereby sunk so that it is adjacent to the seabed 75.

FIG. 15 illustrates what happens when the buoy 59 is filled with gas 71 so that it floats and raises the cable 65.

FIG. 16 shows means to fill and to vent the buoy 59. Gas from a compressed gas container 66 expels the water thereby causing the buoy 59 to float upward and raise the cable(s). Valves for filling and venting 68, 69 are also shown. Note that filling and venting of the buoy 59 is preferably controlled remotely.

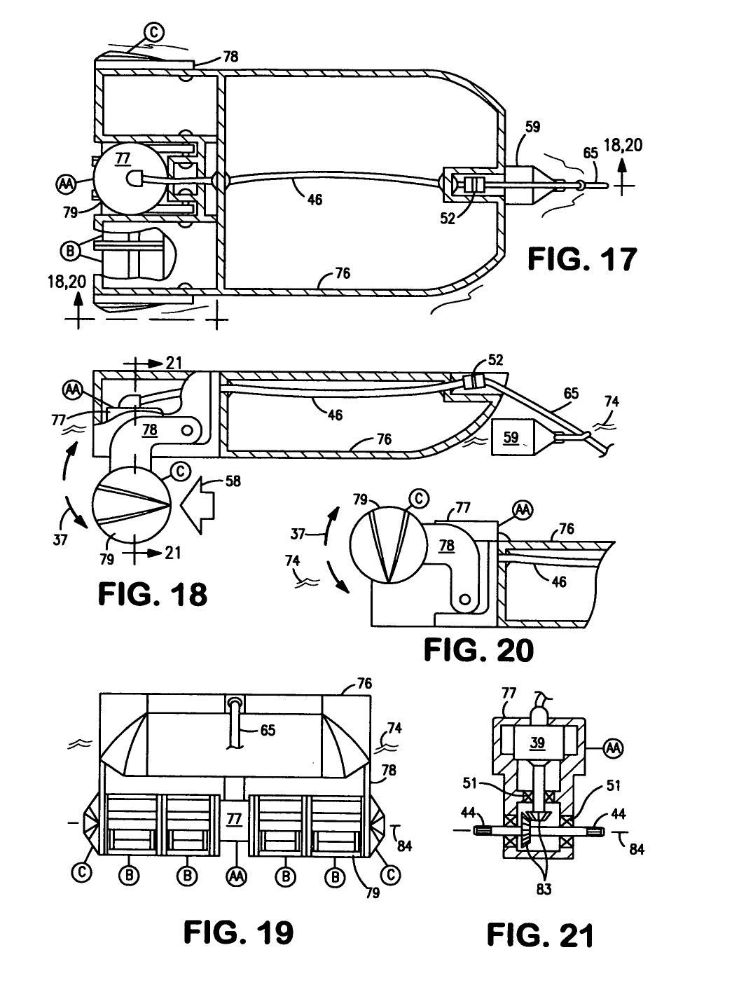

FIG. 17 is a topside view, with deck covering removed, of another waterborne device 76 that is supporting another variant of the instant invention. In this instance, the axis of rotation is horizontal.

FIG. 18 gives a cross sectional view, as taken through line 18-18 of FIG. 17, that shows a plan view of the this horizontal axis variant of the instant invention. A hinge 78 is preferably used when tilting this vertical oriented variant of the instant invention Waterborne Power Generator 64.

FIG. 19 is a bow on view of the waterborne device 76 showing the turbine portion of the Waterborne Power Generator 64 that in this case has rotors that rotate around a horizontal axis.

FIG. 20 shows a partial section, as taken through plane 20-20 of FIG. 17, but with the Waterborne Power Generator 64 in its upper raised position.

FIG. 21 is a cross section, as taken through plane 21-21 of FIG. 18, that shows the preferred arrangement of the power generator and of its driving gear arrangements 83 wherein the generator 39 itself is perpendicular to the axis of rotation.

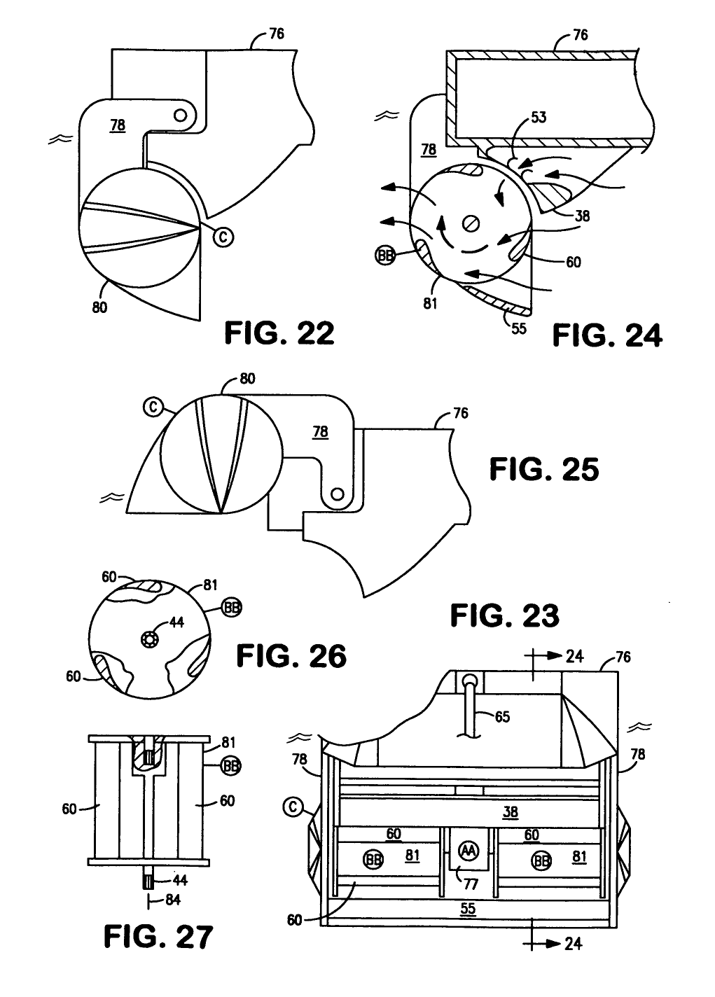

FIG. 22 presents a partial profile view of the aft end of a waterborne device 76 with a slightly different arrangement than given in FIGS. 17-20.

FIG. 23 gives a bow on view of the waterborne device 76 with the horizontal axis Waterborne Power Generator 64 in its lowered powering generating position. It to be noted that other types of rotors and power generator designs can be utilized with the inventive concepts of using a waterborne device and means to raise and lower them from the water as shown herein considered within the spirit and scope of the instant invention.

FIG. 24 presents a cross sectional view, as taken through plane 24-24 of FIG. 23. Note that this situation differs from that presented in FIGS. 17-20 in that a portion of the incoming flow is directed by structure fixed to the waterborne device 76. These include nose nacelle 38 and turning vanes 53. While the flow deflector 55 rotates here with the rotor 81 by means of hinge connector 78, it is of course possible to have the flow deflector 55 fixed to the waterborne device 55 if desired. The rotor 81 is similar in arrangement to the prior art rotor presented in FIG. 2 in the preferred embodiment of the instant invention. It is also quite feasible and considered a part of the invention that the rotor 81 may be independent of any water directing structure wherein it would operate as does the Prior Art rotor shown in FIG. 1. While not as efficient as the preferred embodiments of the instant invention Waterborne Power Generator 64 that have flow directing structure it is workable and considered within the spirit and scope of the instant invention.

FIG. 25 shows this variant of the Waterborne Power Generator 64 in its raised position

FIG. 26 presents and end view of one of the rotor assemblies 81. Note that this rotor 81 is actually similar to that presented as the prior art in FIG. 1.

FIG. 27 is a side or profile view of the rotor 81 shown in FIG. 26.

While the invention has been described in connection with a preferred and several alternative embodiments, it will be understood that there is no intention to thereby limit the invention. On the contrary, there is intended to be covered all alternatives, modifications, and equivalents as may be included within the spirit and scope of the invention as defined by the appended claims, which are the sole definition of the invention.

What I claim is:

1. In a fluid energy powered rotor driven power generation system with said fluid energy powered rotor having fluid energized rotor blades wherein said fluid energized rotor blades absorb energy from oncoming passing fluid currents with said energy transmitted to a power generator for conversion to useful power, the improvement comprising:
a waterborne supporting device supporting said fluid energy powered rotor driven power generation system wherein said waterborne device is attached to non-moving structure by means of connecting means such that said waterborne supporting device orients the fluid energy powered rotor driven power generation system to be facing oncoming passing fluid currents.

2. The fluid energy powered rotor driven power generation system of claim 1 wherein at least a majority of said fluid energized rotor blades may be raised above a surface of passing fluids currents.

3. The fluid energy powered rotor driven power generation system of claim 1 wherein said fluid energized rotor blades absorb energy from rearward flowing incoming fluid during a first portion of rotation of said fluid energy powered rotor and absorb energy from incoming fluid that has been at least partially redirected by fluid flow turning means to be forward flowing over a second portion of rotation of said fluid energy powered rotor thereby providing positive rotational energy over a majority of the rotation of the fluid energy powered rotor.

4. The a fluid energy powered rotor driven power generation system of claim 1 generation system of claim 1 wherein said fluid flow turning means includes fluid flow turning vanes.

5. The fluid energy powered rotor driven power generation system of claim 1 which further comprises flow separation means wherein said flow separation means separates incoming fluid flow to opposite sides of the fluid energy powered rotor.

6. The fluid energy powered rotor driven power generation system of claim 1 which further comprises frontal area increasing outward boundary means that increase the amount of incoming flow directed to the fluid energized rotor blades.

7. The fluid energy powered rotor driven power generating system of claim 6 wherein said frontal area increasing outward boundary means includes stationary curvilinear elements.

8. The fluid energy powered rotor driven power generation system of claim 1 wherein said fluid energy powered rotor driven power generation system includes pre-fabricated modules.

9. The fluid energy powered rotor driven power generation system of claim 6 wherein said pre-fabricated modules include a base module and one or more rotor modules.

10. The fluid energy powered rotor driven power generation system of claim 1 which further comprises one or more fluid flow grilles.

11. The fluid energy powered rotor driven power generation system of claim 5 wherein at least portions of the flow separation means is attached to the waterborne supporting device thereby making said flow separation means fixed in relation to the waterborne supporting device.

12. The fluid energy powered rotor driven power generation system of claim 1 wherein said fluid energized rotor blades rotate around an axis that is more horizontal than vertical.

13. The fluid energy powered rotor driven power generation system of claim 1 wherein said fluid energized rotor blades rotate around an axis that is more vertical than horizontal.

14. The fluid energy powered rotor driven power generation system of claim 1 wherein the connecting means includes a buoy and wherein said buoy may be filled with gas thereby raising said buoy and attached connecting means to a water surface or filled with water thereby lowering said buoy and attached connecting means below the water surface.

15. The fluid energy powered rotor driven power generation system of claim 12 wherein venting and filling of the buoy may be accomplished by remote control means.

16. In a fluid energy powered rotor driven power generation system with said fluid energy powered rotor having fluid energized rotor blades wherein said fluid energized rotor blades absorb energy from oncoming passing fluid currents with said energy transmitted to a power generator for conversion to useful power, the improvement comprising:
a waterborne device supporting said fluid energy powered rotor driven power generation system wherein said fluid energized rotor blades absorb energy from rearward flowing incoming fluid during a first portion of rotation of said fluid energy powered rotor and absorb energy from incoming fluid that has been at least partially redirected by fluid flow turning means to be forward flowing over a second portion of rotation of said fluid energy powered rotor thereby providing positive rotational energy over a majority of the rotation of the fluid energy powered rotor.

17. The fluid energy powered rotor driven power generation system of claim 16 wherein said waterborne device is attached to non-moving structure by means of connecting apparatus such that said waterborne device orients the fluid energy powered rotor driven power generation system to be facing oncoming passing fluid currents.

18. The fluid energy powered rotor driven power generation system of claim 16 wherein said fluid flow turning means includes fluid flow turning vanes.

19. The fluid energy powered rotor driven power generation system of claim 16 which further includes flow separation means forward of said fluid energized rotor blades.

20. The fluid energy powered rotor driven power generation system of claim 19 wherein at least portions of the flow separation means is attached to the waterborne supporting device thereby making said flow separation means fixed in relation to the waterborne supporting device.

21. The fluid energy powered rotor driven power generation system of claim 16 wherein said fluid energized rotor blades rotate around an axis that is more horizontal than vertical.

22. In a fluid energy powered rotor driven power generation system with said fluid energy powered rotor having fluid energized rotor blades wherein said fluid energized rotor blades absorb energy from oncoming passing fluid currents with said energy transmitted to a power generator for conversion to useful power, the improvement comprising:
the connecting means includes a buoy and wherein said buoy may be filled with gas thereby raising said buoy and attached connecting means to a water surface or filled with water thereby lowering said buoy and attached connecting means below the water surface and wherein venting and filling of the buoy may be accomplished by remote control means.
